(19) United States
(12) Patent Application Publication
(10) Pub. No.: US 2017/0205672 A1
(43) Pub. Date: Jul. 20, 2017

(54) LIQUID CRYSTAL DISPLAY PANEL AND DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventor: Hebin Zhao, Beijing (CN)

(21) Appl. No.: 15/214,419

(22) Filed: Jul. 19, 2016

(30) Foreign Application Priority Data
Jan. 18, 2016 (CN) 201610030894.8

(51) Int. Cl. G02F 1/1343; G02F 1/1362; G02F 1/1335

(52) U.S. Cl. CPC G02F 1/134336; G02F 1/133514; G02F 1/136286; G02F 2001/136218; G02F 2201/123; G02F 2201/121; G02F 2203/01; G02F 2203/05

(57) ABSTRACT

A liquid crystal display panel includes an array substrate, a plurality of pixel electrodes which are arranged in matrix on the array substrate, a plurality of gate lines on the array substrate, and a color filter film. A projection of each of the gate lines on the array substrate in a direction perpendicular to the array substrate overlaps with a projection of a row of pixel electrodes on the array substrate in the direction perpendicular to the array substrate, and each of the gate lines extends over an entire length of the row of pixel electrodes in a row direction of pixel electrodes. The color filter film consists of a plurality of column-wise strip-shaped monochrome filter films, each of which covers at least one column of the pixel electrodes.

### CROSS-REFERENCE TO RELATED APPLICATION

This application claims the benefit of Chinese Patent Application No. 201610030894.8 filed on Jan. 18, 2016 in the State Intellectual Property Office of China, the whole disclosure of which is incorporated herein by reference.

### BACKGROUND OF THE INVENTION

Field of the Invention

Embodiments of the present disclosure relate to a field of display technology, in particular, to a liquid crystal display panel and a liquid crystal display device.

Description of the Related Art

With development of liquid crystal display technology, a large-scale liquid crystal display needs a high resolution, however, an increased resolution may affect an aperture ratio adversely, which leads to a reduced transmittance. In order to meet a requirement of transmittance, an Indium Tin Oxide (ITO) transparent electrode is used in a liquid crystal display panel with an Advanced Super Dimension Switch (ADS) mode, in this way, the transmittance may be improved, however, the requirement may still not be met. For example, in an existing liquid crystal display panel with ADS mode as shown in FIG. 1, it comprises a substrate 10, a plurality of common electrodes 11 on the substrate 10, pixel electrodes 12 on the respective common electrodes 11 and gate lines 13 between the pixel electrodes 12. Liquid crystal molecules are deflected by an electric field generated between the gate lines 13 and the pixel/common electrodes 12, 11, as a result, a light leakage occurs. Therefore, it is required to provide a light shield layer 14, which reduces the transmittance.

### SUMMARY OF THE INVENTION

According to an aspect of the present disclosure, it is provided a liquid crystal display panel, comprising an array substrate, a plurality of pixel electrodes which are arranged in matrix on the array substrate, a plurality of gate lines on the array substrate, and a color filter film, wherein a projection of each of the gate lines on the array substrate in a direction perpendicular to the array substrate overlaps with a projection of a row of pixel electrodes on the array substrate in the direction perpendicular to the array substrate, and each of the gate lines extends over an entire length of the row of pixel electrodes in a row direction of pixel electrodes.

In an embodiment, the color filter film comprises a plurality of column-wise strip-shaped monochrome filter films, each of which covers at least one column of the pixel electrodes.

In an embodiment, each of the pixel electrodes has first slits extending in a first direction and second slits extending in a second direction.

In an embodiment, the first slits and the second slits are positioned in an upper region and a lower region of the pixel electrode, respectively, and the gate line is disposed corresponding to a region between the upper region and the lower region.

In an embodiment, the liquid crystal display panel further comprises a plurality of common electrodes on the array substrate, wherein the common electrode covers a gap region between two adjacent pixel electrodes in each column of pixel electrodes.

In an embodiment, the common electrode and the gate line are disposed in the same layer and are insulated with each other, and the common electrode is a common electrode strip extending in the row direction.

In an embodiment, a spacing between each gate line and adjacent common electrodes is within a range of 5 μm to 15 μm.

In an embodiment, the color filter film is an RGB color filter film.

In an embodiment, the monochrome filter films comprise a red filter film, a green filter film and a blue filter film, and the red filter film, the green filter film and the blue filter film are arranged in the row direction of pixel electrodes in that order.

In an embodiment, the color filter film is positioned on the array substrate.

In an embodiment, the liquid crystal display panel further comprises an opposite substrate on which the color filter film is positioned.

According to another aspect of the present disclosure, it is provided a display device comprising the liquid crystal display panel according to any one of the above embodiments.

According to another further aspect of the present disclosure, it is provided a liquid crystal display panel, comprising an array substrate, a plurality of pixel electrodes which are arranged in matrix on the array substrate, and a plurality of gate lines on the array substrate, wherein, the gate lines and the pixel electrodes are positioned in different layers in a direction perpendicular to the array substrate, a projection of each of the gate lines on the array substrate in the direction perpendicular to the array substrate overlaps with a projection of a row of pixel electrodes on the array substrate in the direction perpendicular to the array substrate, and each of the gate lines extends over an entire length of the row of pixel electrodes in a row direction of pixel electrodes.

In an embodiment, the liquid crystal display panel further comprises a plurality of common electrodes on the array substrate, wherein the common electrode and the gate line are disposed in the same layer and are insulated with each other.

### BRIEF DESCRIPTION OF THE DRAWINGS

FIG. 1 is a schematic structural view of an existing liquid crystal display panel;

FIG. 2 is a schematic structural view of a liquid crystal display panel according to an embodiment of the present disclosure;

FIG. 3 is a schematic structural view of a liquid crystal display panel according to an embodiment of the present disclosure, in which a pixel electrode has a two-domain structure;

FIG. 4 is a schematic structural view of a liquid crystal display panel according to an embodiment of the present disclosure, in which common electrodes are shown;

FIG. 5 is a schematic structural view of a liquid crystal display panel according to a further embodiment of the present disclosure; and

FIG. 6 is a comparison diagram of effects of the existing liquid crystal display panel and the liquid crystal display panel according to the embodiments of the present disclosure.

### DETAILED DESCRIPTION OF PREFERRED EMBODIMENTS OF THE INVENTION

A liquid crystal display panel and a liquid crystal display device according to embodiments of the present disclosure will be further described in detail in combination with accompanying drawings and the following embodiments.

Embodiments of the present disclosure aim to provide a liquid crystal display panel and a liquid crystal display device so as to solve a problem that a transmittance of an existing liquid crystal display is low.

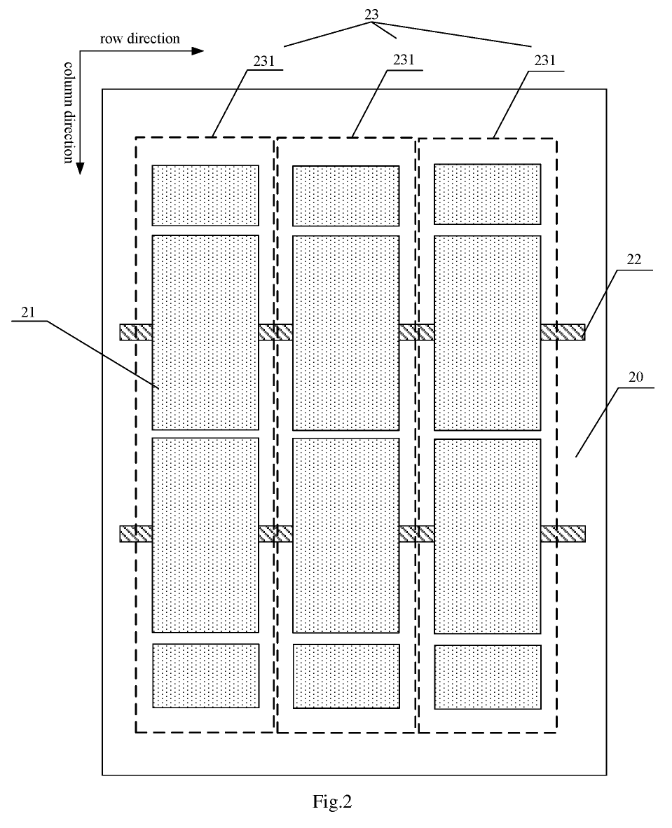

An embodiment of the present disclosure provides a liquid crystal display panel, as shown in FIG. 2, comprising an array substrate 20, a plurality of pixel electrodes 21 which are arranged in matrix (that is, distributed in array) on the array substrate 20, a plurality of gate lines 22 on the array substrate 20, and a color filter film 23. Each of the gate lines 22 is positioned in a region where a row of pixel electrodes 21 are located and extends across the row of pixel electrodes 21.

Further, the color filter film 23 consists of a plurality of column-wise strip-shaped monochrome filter films 231, each of which covers at least one column of the pixel electrodes 21.

It should be noted that, in the embodiment of the present disclosure, the plurality of pixel electrodes 21 are distributed in array, that is, the pixel electrodes 21 may be arranged in both a row direction and a column direction as shown in FIG. 2. The “row direction” may also be referred to as a row direction of pixel electrodes, row-wise direction, etc., and The “column direction” may also be referred to as a column direction of pixel electrodes, column-wise direction, etc. Further, those skilled in the art should understand that such directional expressions are merely used to describe the embodiments of the present disclosure, but they cannot be considered as limiting the embodiments of the present disclosure.

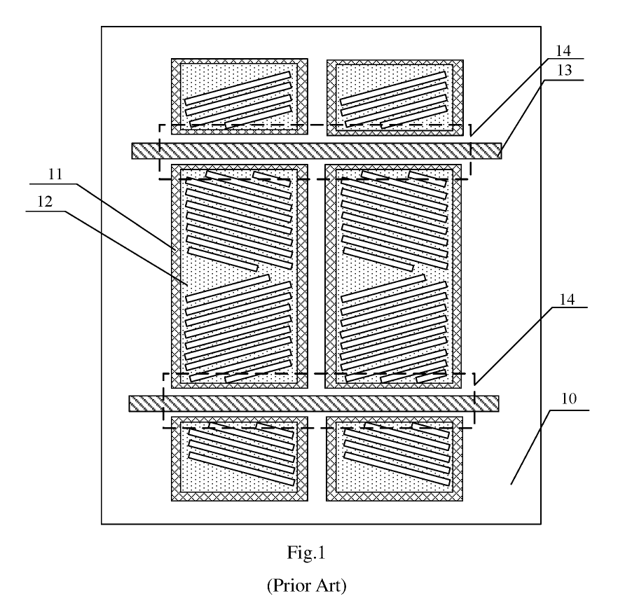

In the embodiment, each of the gate lines 22 is positioned in a region where a row of pixel electrodes 21 are located and extends across the row of pixel electrodes 21, that is, as shown in FIG. 2, a projection of each of the gate lines 22 on the array substrate in a direction perpendicular to the array substrate overlaps with a projection of a row of pixel electrodes 21 on the array substrate in the direction perpendicular to the array substrate, and each of the gate lines 22 extends over an entire length of the row of pixel electrodes 21 in the row direction of pixel electrodes. In contrast, as shown in FIG. 1, each of the gate lines 13 is positioned in a gap region between adjacent pixel electrodes 12, that is, a projection of each of the gate lines 13 in a direction perpendicular to the substrate does not overlap with a projection of a row of pixel electrodes 12 in the direction perpendicular to the substrate.

In the illustrated embodiment, the gate line 22 and the pixel electrode 21 are positioned in different layers in the direction perpendicular to the array substrate, a projection of each of the gate lines on the array substrate in the direction perpendicular to the array substrate overlaps with a projection of a row of pixel electrodes on the array substrate in the direction perpendicular to the array substrate, and each of the gate lines extends over the entire length of the row of pixel electrodes in the row direction of pixel electrodes.

In the embodiment of the present disclosure, as the gate line 22 extends across a row of pixel electrodes 21, that is, extends over the entire length of the row of the pixel electrodes 21 in the row direction of pixel electrodes, on one hand, an electric field generated between the gate line 22 and the pixel electrode 21 is shielded by the pixel electrode 21 so that it cannot affect surrounding liquid crystal molecules, as a result, a light leakage may be avoided and thus no light shield layer is required to be provided on the gate line 22; on the other hand, no gate line is provided between adjacent pixel electrodes 21 so that a light leakage due to the existed gate line may be avoided, as a result, no light shield layer is required to be provided in a gap region between the adjacent pixel electrodes 21, thereby increasing the aperture ratio, increasing the transmittance and improving the display quality. In addition, a monochrome filter film 231 covers on one column of pixel electrodes 21 to ensure there is no difference in filtered color between the gap region and the pixel electrodes 21 of the same one column of pixel electrodes 21, so as to improve further the display quality.

Specifically, the pixel electrode 21 may have a two-domain structure, that is, each of the pixel electrodes 21 has first slits extending in a first direction and second slits extending in a second direction.

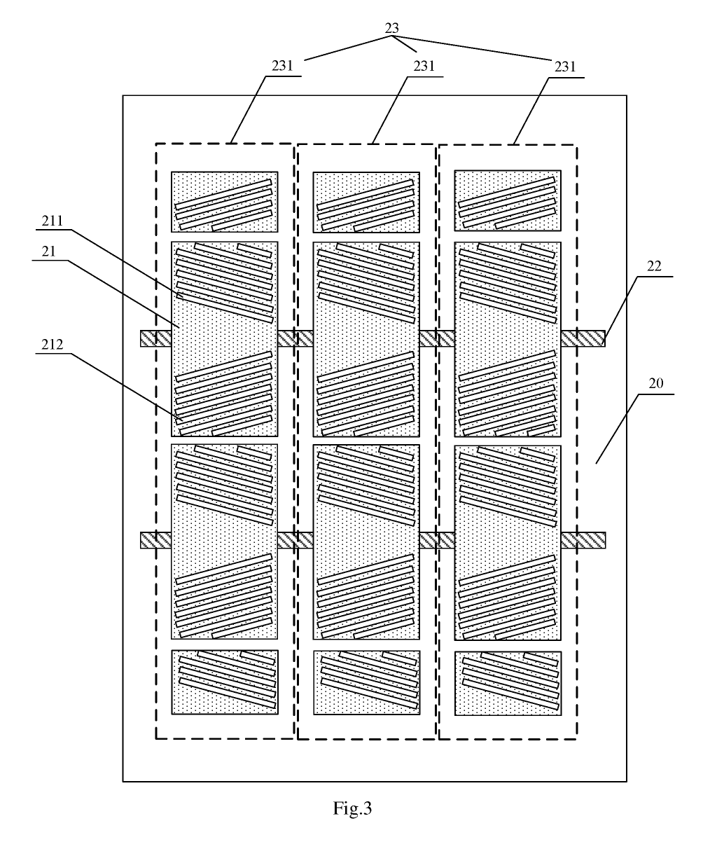

Further, as shown in FIG. 3, the first slits 211 and the second slits 212 are positioned in an upper region and a lower region of the pixel electrode 21, respectively, and the gate line 22 is disposed corresponding to a region between the upper region and the lower region, that is, a projection of the gate line 22 on the array substrate in the direction perpendicular to the array substrate overlaps with a projection of the region between the upper region and the lower region of the pixel electrode 21 on the array substrate in the direction perpendicular to the array substrate.

In the embodiment, the gate line 22 is positioned in a region where no slit is disposed in the pixel electrode 21 having two-domain structure, so as to ensure the pixel electrode 21 functions to shield the electric field generated between the gate line 22 and the pixel electrode 21.

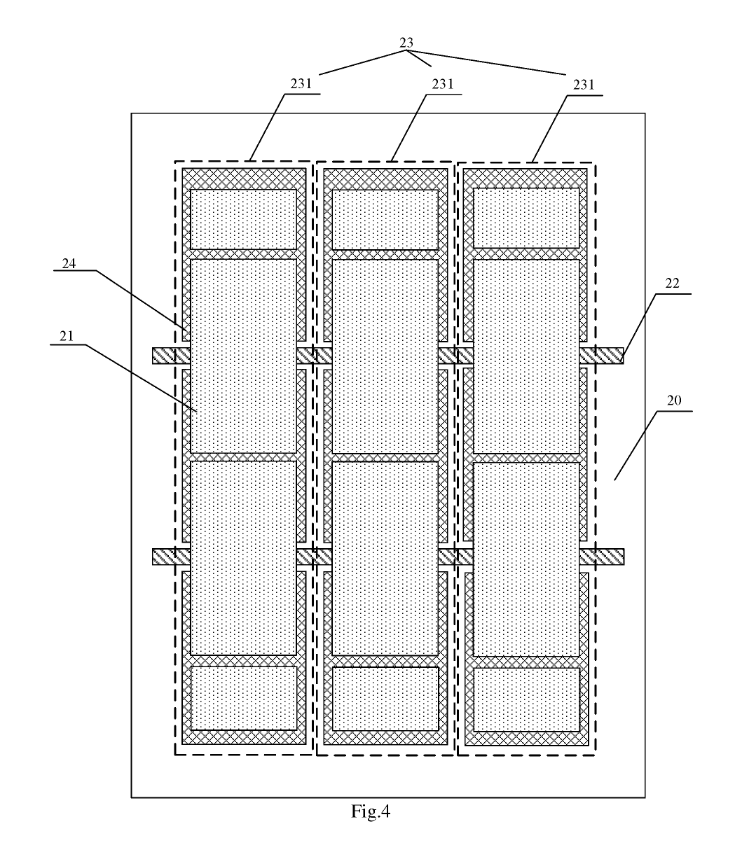

Further, as shown in FIG. 4, the liquid crystal display panel according to any one of the above embodiments comprises a plurality of common electrodes 24 on the array substrate. The common electrode 24 covers a gap region between two adjacent pixel electrodes 21 in each column of pixel electrodes 21.

Of course, an electric field generated between the gate line 22 and the common electrode 24 will also be shielded by the pixel electrode 21.

Further, the common electrode 24 and the gate line 22 may be disposed in the same layer and be insulated with each other. Also, the common electrode 24 is a common electrode strip extending in a row direction.

In the embodiment, a predefined distance is set between the gate line 22 and the common electrode 24 in order to avoid a short circuit therebetween.

Further, the predefined distance between each gate line 22 and adjacent common electrode strips may be within a range of 5 μm to 15 μm.

Further, the color filter film may include RGB (Red Green Blue) color filter film, however, it is not limited thereto.

Further, the color filter film is positioned on the array substrate.

Further, the liquid crystal display panel according to any one of the above embodiments comprises an opposite substrate on which the color filter film is positioned.

Further, the liquid crystal display panel according to any one of the above embodiments may be a liquid crystal display panel with ADS mode, however, it is not limited thereto.

Next, a liquid crystal display panel according to an embodiment of the present disclosure will be explained in further detail by taking an RGB color filter film as an example.

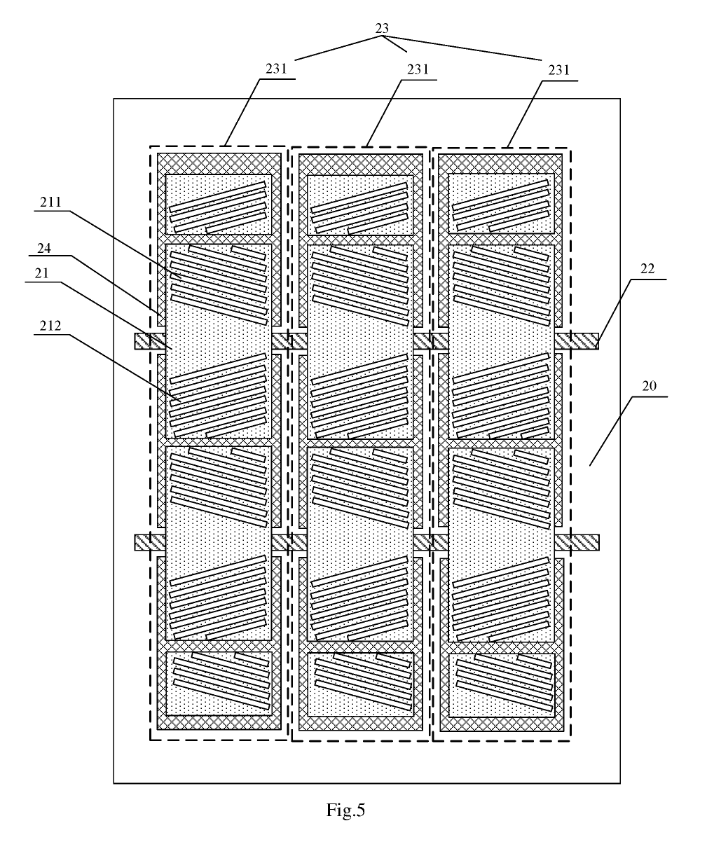

The liquid crystal display panel as shown in FIG. 5 may comprise an array substrate 20, a plurality of pixel electrodes 21 which are arranged in matrix on the array substrate 20, a plurality of gate lines 22 on the array substrate 20, a color filter film 23, and a plurality of common electrodes 24 on the array substrate.

Each of the gate lines 22 is positioned in a region where a row of pixel electrodes 21 are located and extends across the row of pixel electrodes 21.

Further, each of the pixel electrodes 21 may have first slits 211 extending in a first direction and second slits 212 extending in a second direction. The first slits 211 and the second slits 212 are positioned in an upper region and a lower region of the pixel electrode 21, respectively, and the gate line 22 is disposed corresponding to a region between the upper region and the lower region.

Further, the common electrode 24 is a common electrode strip extending in a column direction to cover a gap region between two adjacent pixel electrodes 21 in each column of the pixel electrodes 21. Also, the common electrode 24 and the gate line 22 are disposed in the same layer and insulated with each other. A spacing between each gate line 22 and adjacent common electrode strips may be within a range of 5 μm to 15 μm.

The color filter film is an RGB color filter film and is positioned on an opposite substrate (not shown in FIG. 5). The color filter film consists of a plurality of column-wise strip-shaped monochrome filter films 231 (i.e., red filter film, green filter film and blue filter film). Each of the monochrome filter films 231 covers a column of pixel electrodes, and the monochrome filter films 231 are arranged in an order of red filter film, green filter film and blue filter film.

The opposite substrate is a color filter substrate.

In the embodiment, the liquid crystal display panel has an ADS mode.

Compared to the existing liquid crystal display panel, the liquid crystal display panel according to the embodiments of the present disclosure may have the following effects.

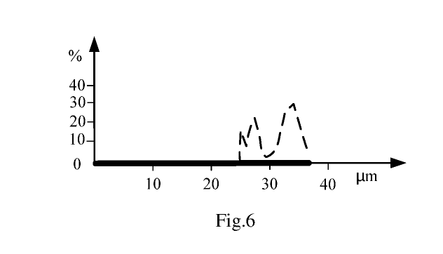

When the pixel electrode and the common electrode are not powered, a light transmittance measured in and around a gate line starting from a side of the gate line in a direction perpendicular to the gate line is shown in FIG. 6. A dashed line indicates an effect of the existing liquid crystal display panel, and a bold solid line indicates an effect of the liquid crystal display panel according to the embodiments of the present disclosure. The gate line has a width of 26 μm, and the light transmittance over the width of the gate line is equal to zero as the gate line itself is light-proof. Around the gate line, the light transmittance measured in the existing liquid crystal display panel is larger than zero, which indicates that the electric field generated between the gate line and the pixel/common electrodes has adversely affected the liquid crystal molecules, and the liquid crystal molecules have been deflected so that light leakage occurs. In contrast, around the gate line, the light transmittance measured in the liquid crystal display panel according to the embodiments of the present disclosure is equal to zero, which indicates that the electric field generated between the gate line 22 and the pixel/common electrodes 21, 24 has been shielded by the pixel electrode 21 so that the liquid crystal molecules are not deflected, thus no light leakage occurs, as a result, no black matrix is required to be provided on the color filter substrate to shield light, thereby increasing light transmittance.

For a region between adjacent pixel electrodes, when the pixel electrode and the common electrode are not powered, it can be seen from FIG. 6 that the light transmittance measured in the region between adjacent pixel electrodes (that is, in and around the gate line) in the existing liquid crystal display panel is larger than zero, which indicates that the liquid crystal molecules have been deflected so that light leakage occurs. In contrast, the light transmittance measured in the region between adjacent pixel electrodes in the liquid crystal display panel according to the embodiments of the present disclosure is equal to zero, which indicates that the liquid crystal molecules are not deflected, thus no light leakage occurs, as a result, no black matrix is required to be provided on the color filter substrate to shield light, thereby increasing light transmittance.

When the pixel electrode 21 and the common electrode 24 are powered, as the monochrome filter film 231 covers one column of pixel electrodes 21, the color of light in the region between adjacent pixel electrodes 21 is the same as the color of light in the region where the pixel electrode 21 is located, thereby improving the display quality.

Based on the same inventive concept, an embodiment of the present disclosure further provides a display device comprising the liquid crystal display panel according to any one of the above embodiments.

In the liquid crystal display panel and display device according to the embodiments of the present disclosure, as the gate line extends across a row of pixel electrodes, on one hand, an electric field generated between the gate line and the pixel electrode is shielded by the pixel electrode so that it cannot affect surrounding liquid crystal molecules, as a result, a light leakage may be avoided and thus no light shield layer is required to be provided on the gate line; on the other hand, no gate line is provided between adjacent pixel electrodes so that a light leakage due to the existed gate line may be avoided, as a result, no light shield layer is required to be provided in a gap region between the adjacent pixel electrodes, thereby increasing the aperture ratio, increasing the transmittance and improving the display quality. In addition, a monochrome filter film covers on one column of pixel electrodes to ensure there is no difference in filtered color between the gap region and the pixel electrodes of the same one column of pixel electrodes, so as to improve further the display quality.

Though the preferable embodiments of the present disclosure have been described, those skilled in the art can make further changes and modifications to these embodiments based on the basic inventive concept. Thus, the appended claims are intended to include all the preferable embodiments and all the changes and modifications which fall into the scope of the present disclosure.

Obviously, the changes and modifications can be made by those skilled in the art without departing from the spirit and scope of the present disclosure. Thus, the present is intended to include these changes and modifications if they fall into the scope of the claims and equivalents thereof.

What is claimed is:

1. A liquid crystal display panel, comprising an array substrate, a plurality of pixel electrodes which are arranged in matrix on the array substrate, a plurality of gate lines on the array substrate, and a color filter film, wherein,
a projection of each of the gate lines on the array substrate in a direction perpendicular to the array substrate overlaps with a projection of a row of pixel electrodes on the array substrate in the direction perpendicular to the array substrate, and each of the gate lines extends over an entire length of the row of pixel electrodes in a row direction of pixel electrodes.

2. The liquid crystal display panel according to claim 1, wherein, the color filter film comprises a plurality of column-wise strip-shaped monochrome filter films, each of which covers at least one column of the pixel electrodes.

3. The liquid crystal display panel according to claim 1, wherein each of the pixel electrodes has first slits extending in a first direction and second slits extending in a second direction.

4. The liquid crystal display panel according to claim 3, wherein, the first slits and the second slits are positioned in an upper region and a lower region of the pixel electrode, respectively, and the gate line is disposed corresponding to a region between the upper region and the lower region.

5. The liquid crystal display panel according to claim 1, further comprising a plurality of common electrodes on the array substrate, wherein the common electrode covers a gap region between two adjacent pixel electrodes in each column of pixel electrodes.

6. The liquid crystal display panel according to claim 3, further comprising a plurality of common electrodes on the array substrate, wherein the common electrode covers a gap region between two adjacent pixel electrodes in each column of pixel electrodes.

7. The liquid crystal display panel according to claim 5, wherein, the common electrode and the gate line are disposed in the same layer and are insulated with each other, and the common electrode is a common electrode strip extending in the row direction.

8. The liquid crystal display panel according to claim 6, wherein, the common electrode and the gate line are disposed in the same layer and are insulated with each other, and the common electrode is a common electrode strip extending in the row direction.

9. The liquid crystal display panel according to claim 7, wherein a spacing between each gate line and adjacent common electrodes is within a range of 5 μm to 15 μm.

10. The liquid crystal display panel according to claim 8, wherein a spacing between each gate line and adjacent common electrodes is within a range of 5 μm to 15 μm.

11. The liquid crystal display panel according to claim 1, wherein the color filter film is an RGB color filter film.

12. The liquid crystal display panel according to claim 2, wherein the color filter film is an RGB color filter film.

13. The liquid crystal display panel according to claim 12, wherein, the monochrome filter films comprise a red filter film, a green filter film and a blue filter film, and the red filter film, the green filter film and the blue filter film are arranged in the row direction of pixel electrodes in that order.

14. The liquid crystal display panel according to claim 1, wherein the color filter film is positioned on the array substrate.

15. The liquid crystal display panel according to claim 2, wherein the color filter film is positioned on the array substrate.

16. The liquid crystal display panel according to claim 1, further comprising an opposite substrate on which the color filter film is positioned.

17. The liquid crystal display panel according to claim 2, further comprising an opposite substrate on which the color filter film is positioned.

18. A display device comprising the liquid crystal display panel according to claim 1.

19. A liquid crystal display panel, comprising an array substrate, a plurality of pixel electrodes which are arranged in matrix on the array substrate, and a plurality of gate lines on the array substrate, wherein,
the gate lines and the pixel electrodes are positioned in different layers in a direction perpendicular to the array substrate, a projection of each of the gate lines on the array substrate in the direction perpendicular to the array substrate overlaps with a projection of a row of pixel electrodes on the array substrate in the direction perpendicular to the array substrate, and each of the gate lines extends over an entire length of the row of pixel electrodes in a row direction of pixel electrodes.

20. The liquid crystal display panel according to claim 19, further comprising a plurality of common electrodes on the array substrate, wherein the common electrode and the gate line are disposed in the same layer and are insulated with each other.
